(19) United States
(12) Patent Application Publication
(10) Pub. No.: US 2022/0338670 A1
(43) Pub. Date: Oct. 27, 2022

(54) SYSTEM, APPARATUS, AND METHOD FOR POWERING A THERMAL DEVICE

(71) Applicant: EcoSimmer Outdoors Inc., Tahoe City, CA (US)

(72) Inventors: Thomas Swift, Seattle, WA (US); William Swift, Tahoe City, CA (US)

(21) Appl. No.: 17/411,391

(22) Filed: Aug. 25, 2021

Related U.S. Application Data
(60) Provisional application No. 63/180,511, filed on Apr. 27, 2021.

(51) Int. Cl. A47J 36/24; H05B 3/06

(52) U.S. Cl. CPC A47J 36/2472; H05B 3/06; H05B 2203/021; H05B 2203/016

(57) ABSTRACT

An apparatus is disclosed. The apparatus has an outer housing, an inner housing disposed in the outer housing and forming a gap between an exterior surface of the inner housing and an interior surface of the outer housing, one or more thermal devices disposed in the gap, and an electrical port disposed in or on the outer housing and electrically connected to the one or more thermal devices.

### RELATED APPLICATIONS

This application claims the benefit of U.S. Provisional Patent Application No. 63/180,511 filed Apr. 27, 2021, which is hereby incorporated by reference in its entirety.

### TECHNICAL FIELD

The present disclosure generally relates to a system, apparatus, and method for powering a device, and more particularly to a system, apparatus, and method for powering a thermal device.

### BACKGROUND

Conventional cooking and heating systems exist for backcountry applications such as camping, hiking, and other outdoor activities. Typical backcountry cooking and heating systems employ a flame or fire for cooking and heating such as burning wood or charcoal or utilizing a gas or propane stove. Other conventional systems include solar cookers, but such systems typically depend on the weather being exceptionally sunny to operate effectively.

Conventional systems are typically difficult to use, involve challenges in managing flames, are heavy and/or bulky and therefore difficult to transport, and/or are not approved for certain types of travel such as air travel (e.g., a gas or propane canister system may not be brought on commercial aircraft). Further, as wildfires have become increasingly common and more dangerous in recent years, governments and regulatory bodies have limited or regulated the use of open flames in the outdoors (e.g., on the U.S. west coast).

Conventional solutions that address the above issues generally involve low temperature ranges. For example, such conventional systems are typically not able to boil water.

The exemplary disclosed system, apparatus, and method are directed to overcoming one or more of the shortcomings set forth above and/or other deficiencies in existing technology.

### SUMMARY OF THE DISCLOSURE

In one exemplary aspect, the present disclosure is directed to an apparatus. The apparatus includes an outer housing, an inner housing disposed in the outer housing and forming a gap between an exterior surface of the inner housing and an interior surface of the outer housing, one or more thermal devices disposed in the gap, and an electrical port disposed in or on the outer housing and electrically connected to the one or more thermal devices.

In another aspect, the present disclosure is directed to a method. The method includes providing an outer housing, disposing an inner housing in the outer housing and forming a gap between an exterior surface of the inner housing and an interior surface of the outer housing, disposing a plurality of thermal devices in the gap, disposing an electrical port in or on the outer housing, powering the plurality of thermal devices via the electrical port, and sensing a temperature at the exterior surface of the inner housing.

### BRIEF DESCRIPTION OF THE DRAWINGS

FIG. 1 illustrates a side view of at least some exemplary embodiments of the present disclosure;

FIG. 2 illustrates a perspective, exploded view of at least some exemplary embodiments of the present disclosure;

FIG. 3 illustrates a perspective, exploded view of at least some exemplary embodiments of the present disclosure;

FIG. 4 illustrates a perspective view of an exemplary component of at least some exemplary embodiments of the present disclosure;

FIG. 5 illustrates a perspective view of an exemplary component of at least some exemplary embodiments of the present disclosure;

FIG. 6 illustrates a perspective view of an exemplary component of at least some exemplary embodiments of the present disclosure;

FIG. 7 illustrates a perspective view of an exemplary component of at least some exemplary embodiments of the present disclosure;

FIG. 8 illustrates a perspective view of an exemplary component of at least some exemplary embodiments of the present disclosure;

FIG. 9 illustrates a schematic view of at least some exemplary embodiments of the present disclosure;

FIG. 10 illustrates an exemplary process of at least some exemplary embodiments of the present disclosure;

FIG. 11 illustrates a perspective, exploded view of at least some exemplary embodiments of the present disclosure;

FIG. 12 is a schematic illustration of an exemplary computing device, in accordance with at least some exemplary embodiments of the present disclosure; and

FIG. 13 is a schematic illustration of an exemplary network, in accordance with at least some exemplary embodiments of the present disclosure.

### DETAILED DESCRIPTION AND INDUSTRIAL APPLICABILITY

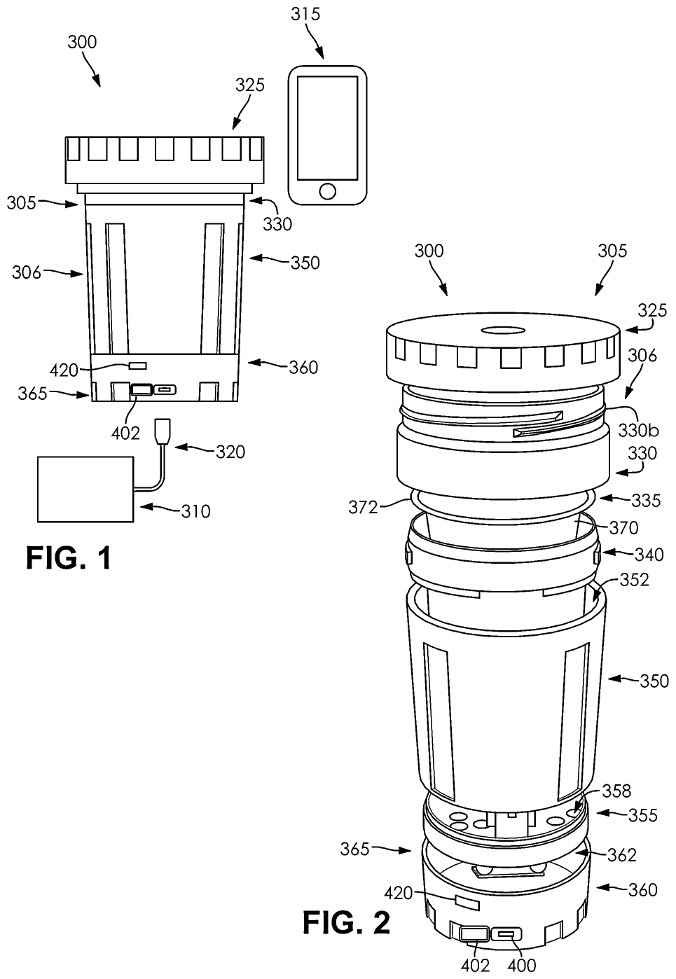

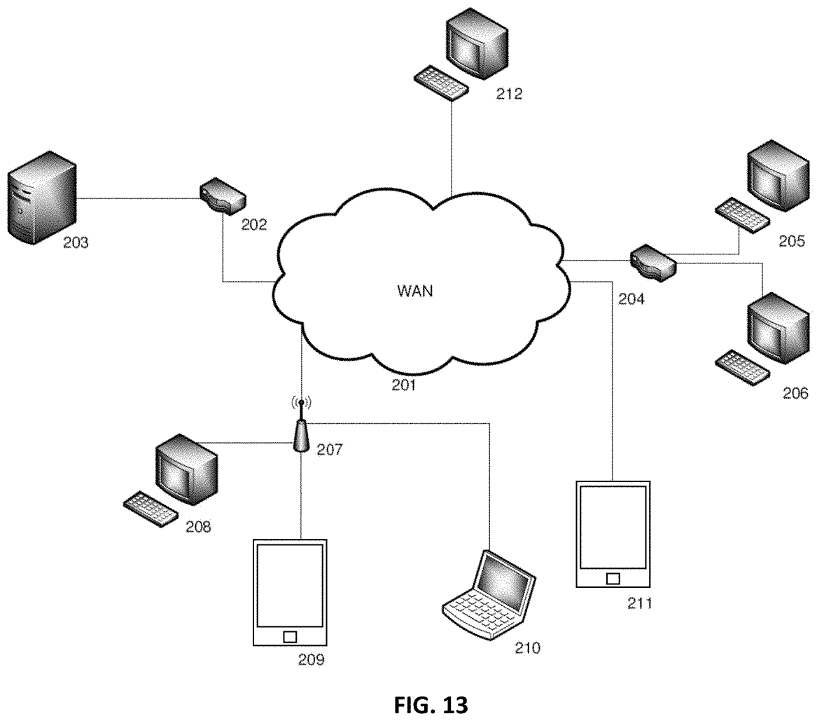

The exemplary disclosed system, apparatus, and method may include an electrical system such as, for example, an electrical cooking system, an electrical heating and/or cooling system, and/or any other suitable electrically-powered system. In at least some exemplary embodiments and as illustrated in FIGS. 1 and 2, the exemplary disclosed system, apparatus, and method may include a system 300. System 300 may include an apparatus 305 that may be powered by any suitable power source such as a power source 310. Apparatus 305 may communicate with any suitable user device and/or network (e.g., a network as described herein regarding FIG. 13) such as, for example, a user device 315.

Power source 310 may be any suitable power source for powering apparatus 305. Power source 310 may be external to apparatus 305. Power source 310 may be any suitable device for providing electrical power to apparatus 310. Power source 310 may be a power storage. Power source 310 may be a battery. Power source 310 may be a rechargeable battery. In at least some exemplary embodiments, power source 310 may include a nickel-metal hydride battery, a lithium-ion battery, an ultracapacitor battery, a lead-acid battery, and/or a nickel cadmium battery. In at least some exemplary embodiments, power source 310 may be a USB-C battery. In at least some exemplary embodiments, power source 310 may include any suitable USB-C device such as, for example, a 100 W USB-C cable converted and connected to an AC wall outlet or a DC car outlet. Power source 310 may be electrically connected to exemplary disclosed electrical components of apparatus 305 for example as described below via a connector 320 such as an electrical cable, cord, or any other suitable electrical connector. In at least some exemplary embodiments, connector 320 may include an electrical port (e.g., a USB port such as a USB-C port). Power source 310 may provide a continuous electrical output. For example, power source 310 may provide a continuous output of at least 60 W.

User device 315 may be any suitable user device for receiving input and/or providing output (e.g., raw data or other desired information) to a user. User device 315 may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300, and/or any other suitable user device or interface. For example, user device 315 may include a touchscreen device of a smartphone or handheld tablet. For example, user device 315 may include a display that may include a graphical user interface to facilitate entry of input by a user and/or receiving output. For example, system 300 may provide notifications to a user via output transmitted to user device 315. User device 315 may communicate with components of apparatus 305 by any suitable technique such as, for example, as described below.

As illustrated in FIGS. 1-9, apparatus 305 may include a lid member 325, a lip member 330, a thermal assembly 335, a washer member 340, insulation 345, a sleeve member 350, an intermediate member 355, a base member 360, and a control assembly 365. Lip member 330, washer member 340, sleeve member 350, intermediate member 355, and base member 360 may form a structural assembly 306 for supporting lid member 325, thermal assembly 335, insulation 345, and control assembly 365. As an alternative to the exemplary embodiments illustrated in FIGS. 1-3, structural assembly 306 may include any suitable configuration or assembly of members for supporting lid member 325, thermal assembly 335, insulation 345, and control assembly 365 (e.g., such as a single integral member or assembly including a different configuration of structural embers). Structural assembly 306 may form an outer housing.

Lip member 330, sleeve member 350, and base member 360 may form an exterior (e.g., an outer container or outer housing) of apparatus 305. Lid member 325 may be removably attached to lip member 330. Lip member 330, sleeve member 350, and base member 360 may be formed from any suitable non-thermally conductive material such as, for example, plastic, ceramic, natural or synthetic rubber or elastomeric material, and/or any other suitable non-thermally conductive material. Base member 360 may form a bottom surface of apparatus 305, lip member 330 may form an open top of apparatus 305 (e.g., to which lid member 325 may be removably attached), and sleeve member 350 may form a sidewall extending between the bottom surface formed by base member 360 and the open top formed by lip member 330.

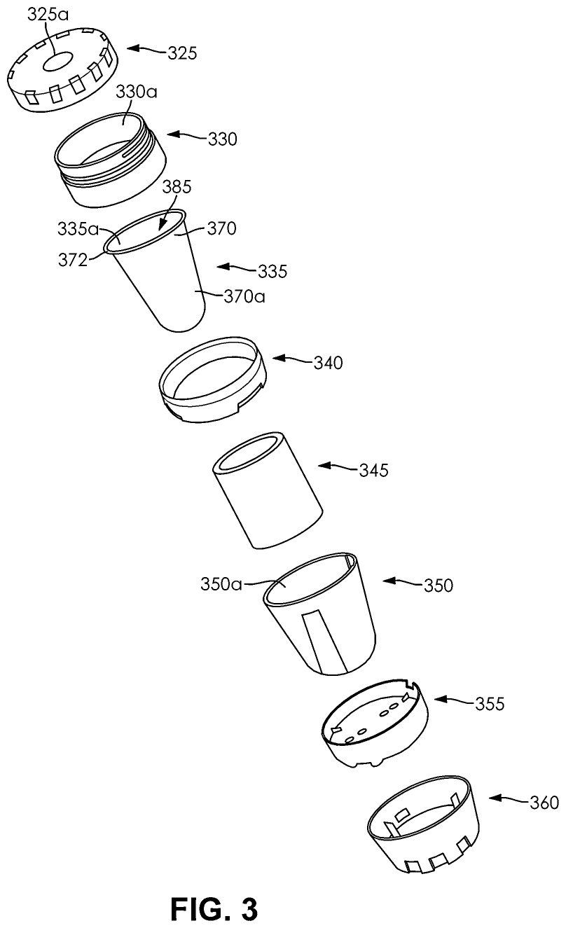

Lip member 330 may form a top portion of apparatus 305 having an inside shape (e.g., diameter) or configuration that may be substantially flush with a cavity (e.g., an interior cavity) of thermal assembly 335 so as to form a continuous interior surface that increases a height of a material-holding (e.g., fluid-holding) interior cavity of apparatus 305. For example as illustrated in FIG. 3, an interior surface 335a of thermal assembly 335 and an interior surface 330a of lip member 330 may be substantially flush so that lip member 330 increases a height of a material-holding interior cavity of apparatus 305. This additional height formed from the exemplary disclosed non-thermally conductive material may help prevent a user from easily contacting a thermally conducting inner container formed by thermal assembly 335 for example as described herein (e.g., such as when a user drinks directly from or handles apparatus 305). In at least some exemplary embodiments, lip member 330 may be formed from polycarbonate (PC) material. As illustrated in FIG. 2, a plurality of protrusions 330b (e.g., threads) may be disposed at an exterior surface of lip member 330, which may be configured to be received by corresponding recesses and/or protrusions disposed at an interior surface of lid member 325 (e.g., so that lid member 325 may be fastened or screwed on lip member 330). Lid member 325 and/or lip member 330 may include any other suitable configuration of recesses, protrusions, adhesive surfaces, magnetic surfaces, and/or any other suitable mechanical fastening devices so that lid member 325 may be removably attached to lip member 330.

Sleeve member 350 may be configured to receive thermal assembly 335. When thermal assembly 335 is received in sleeve member 350, a gap 352 may be formed between an interior surface 350a of sleeve member 350 and an exterior surface 370a of thermal assembly 335. Gap 352 may be large enough to receive insulation 345 that may be disposed between interior surface 350a of sleeve member 350 and the exterior surface of thermal assembly 335. Gap 352 may also be large enough to receive the exemplary disclosed components (e.g., sensor and/or thermal devices as described herein) of thermal assembly 335 and/or control assembly 365 (e.g., a display as described herein). For example, a sidewall of sleeve member 350 may be spaced some distance away from a sidewall of thermal assembly 335. Sleeve member 350 may be sized so that a user may comfortably grip and hold apparatus 305 with one hand. In at least some exemplary embodiments, a portion or substantially all of sleeve member 350 may be formed from transparent and/or translucent material (e.g., including semi-transparent and/or semi-translucent material). For example, the material of sleeve member 350 may be exemplary disclosed non-thermally conductive material having sufficient transparency or translucence (e.g., sufficiently lacking opacity) so that the exemplary disclosed components (e.g., display) of control assembly 365 (e.g., that may be disposed in gap 352 formed between interior surface 350a of sleeve member 350 and exterior surface 370a of thermal assembly 335) may be viewed or may be visible by a user through sleeve member 350. For example, a display element such as the exemplary disclosed lighting elements of control assembly 365 described herein may be viewed through sleeve member 350. An exterior surface of sleeve member 350 may be textured (e.g., including a plurality of protrusions and/or including a textured surface) for relatively easy gripping by a user.

In at least some exemplary embodiments, a portion of sleeve member 350 and/or a portion of base member 360 may be formed from non-thermally conductive and non-electrically conductive material that may be impact resistant and that may provide adhesion (e.g., adhesive contact) to a surface on which apparatus 305 may be placed. For example, a portion of sleeve member 350 and/or a portion of base member 360 may be formed from natural or synthetic rubber or elastomeric material. In at least some exemplary embodiments, base member 360 may be formed from thermoplastic elastomer (TPE) material. Base member 360 may be spaced sufficiently from a bottom portion of intermediate member 355 to provide a gap or cavity 362 (e.g., a compartment) so that the exemplary disclosed components (e.g., sensor and/or thermal devices) of thermal assembly 335 and/or control assembly 365 (e.g., controller) may be disposed in the gap and/or cavity 362. In at least some exemplary embodiments, gap or cavity 362 may be a substantially watertight compartment. In at least some exemplary embodiments, thermal assembly 335 may include cantilever snap joints that may allow thermal assembly 335 to be snapped into place (e.g., at intermediate member 355 and/or base member 360). The exemplary disclosed components may include apertures (e.g., channels) for wires to pass through so that the exemplary disclosed heating elements, sensors, and/or front PCB wires may be plugged into exemplary disclosed electrical components that may be affixed to thermal assembly 335.

Insulation 345 may include one or more insulation layers disposed between interior surface 350a of sleeve member 350 and exterior surface 370a of thermal assembly 335. Insulation 345 may be formed from any suitable insulation material such as thermal batting, mylar, fabric, foam, a silicone insulator, a rubber-like or elastomeric insulator, and/or any other suitable insulation material. Insulation 345 may include insulating materials that may be thermally insulating and/or may be heat-reflective. For example, materials of insulation 345 may be oriented to direct heat back toward thermal assembly 335, or may be oriented to distribute heat over their surface area. In at least some exemplary embodiments, a metal foil layer may be included in insulation 345 (e.g., directly above the exemplary disclosed heating elements) that may mitigate hot spots by distributing heat.

Insulation 345 may cover a surface area of the exemplary disclosed heating elements of thermal assembly 335 disposed in a gap or space formed between the heating elements (e.g., and any other suitable components of thermal assembly 335) and interior surface 350a of sleeve member 350. In at least some exemplary embodiments, insulation 345 may be attached to (e.g., adhered to or fastened by any suitable fasteners such as mechanical fasteners) thermal assembly 335.

Washer member 340 may be formed from material similar to lip member 330 and/or sleeve member 350. In at least some exemplary embodiments, washer member 340 may be formed from polycarbonate (PC) material. Washer member 340 may be received in sleeve member 350 (e.g., may contact or abut against interior surface 350a of sleeve member 350). Washer member 340 may be received in lip member 330 (e.g., may contact or abut against interior surface 330a of lip member 330).

Intermediate member 355 may be formed from material similar to lip member 330 and/or sleeve member 350. In at least some exemplary embodiments, intermediate member 355 may be formed from polycarbonate (PC) material. Intermediate member 355 may be received and supported within base member 360 so as to form cavity 362. An upper surface of intermediate member 355 may be spaced from a bottom portion of thermal assembly 335 so as to form a cavity 358. In at least some exemplary embodiments, thermal assembly 335 may be supported at lip 372 by lip member 330 and/or washer member 340. Alternatively for example, a bottom portion of thermal assembly 335 may directly contact the upper surface of intermediate member 355. Exemplary disclosed components of thermal assembly 335 and/or portions of insulation 345 may be disposed in cavity 358. Intermediate member 355 may include any suitable protrusions, recesses, and/or apertures for receiving and/or supporting components of thermal assembly 335 (e.g., and/or control assembly 365). Intermediate member 355 may provide a surface to which electrical components of control assembly 365 described below may be attached (e.g., affixed). Intermediate member 355 may also provide additional mechanical support for attaching (e.g., joining) sleeve member 350 and base member 360.

Lid member 325 may be removably attached to lip member 330 (e.g., for example as described above) so that lid member 325 covers the exemplary disclosed inner cavity or container of apparatus 305 formed by lip member 330 and thermal assembly 335. For example, lid member 325 may cover the contents of the exemplary disclosed inner cavity to substantially contain thermal energy (e.g., contain the majority of thermal energy) stored within a material such as food or beverage stored in apparatus 305. Lid member 325 may include at least one aperture 325a (e.g., a hole or through-hole) to allow for excess heat or pressure to escape from the exemplary disclosed interior cavity during an operation of apparatus 305. Lid member 325 may include protrusions (e.g., or any other suitable mechanism or device) for engaging with lip member 330 (e.g., with protrusions 330b). Lid member 325 may thereby be securely removably attached or affixed to a top of apparatus 305 (e.g., to lip member 330) to provide a spill-resistant seal. For example in view of at least one aperture 325a being formed in lid member 325, the seal may be spill-resistant. Lid member 325 may be formed from material similar to lip member 330 and/or sleeve member 350. A portion or substantially all of lid member 325 may be formed from impact resistant material (e.g., to improve a durability of apparatus 305 in the event that it is dropped by a user). In at least some exemplary embodiments, lid member 325 may be formed from polycarbonate (PC) material and/or thermoplastic elastomer (TPE) material.

Thermal assembly 335 may include a housing 370, one or more thermal devices 375, and one or more sensors 380. Thermal device 375 may change a temperature of material disposed in housing 370. Sensor 380 may sense properties of material disposed in housing 370.

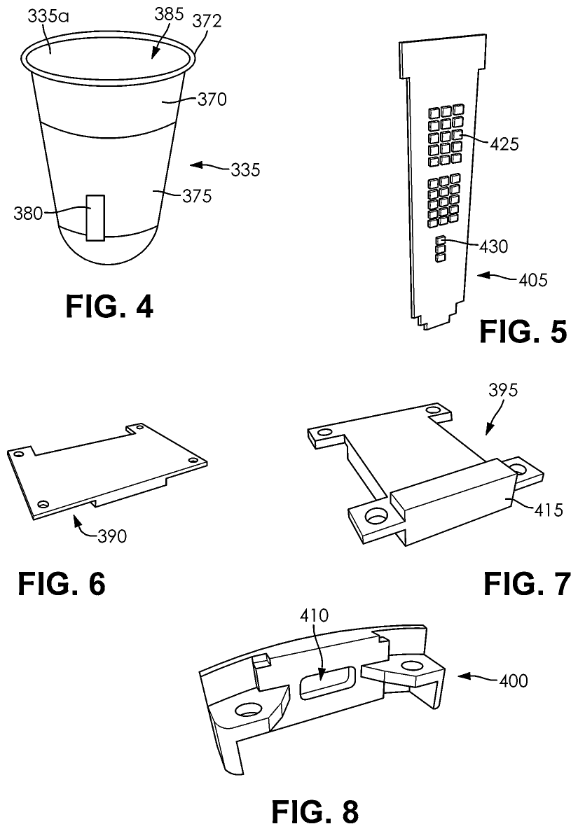

For example as illustrated in FIGS. 3 and 4, housing 370 may be any suitable container for holding material such as a food or beverage. Housing 370 may be any suitable container for holding a food or beverage during cooking (e.g., when apparatus 305 is a cooking device) or heating or freezing (e.g., when apparatus 305 is a heating device and/or a freezing device). Housing 370 may be any suitable container for holding any material that may undergo a change in temperature based on an operation of apparatus 305. Housing 370 may be formed from any suitable thermally conductive material (e.g., thermally conductive structural material) such as metal, composite material, or any other suitable material for holding material during a temperature change of the material. Housing 370 may be made of steel material such as stainless steel. Housing 370 may be a cup-shaped container including an integrally-formed (e.g., and/or attached) bottom and side portions and an open top portion. Interior surface 335a of housing 370 may form a cavity 385 that may hold the exemplary disclosed material. For example as described above, interior surface 335a may be flush with interior surface 330a of lip member 330 to extend a height of cavity 385 using lip member 330. Housing 370 may include a bottom surface formed by a bottom portion, an open top, and a sidewall extending between the bottom surface and the open top, thereby forming cavity 385 that may be an interior container of apparatus 305 configured to receive a food or a beverage. Housing 370 may be disposed on (e.g., sit on) intermediate member 355 or may be supported above (e.g., slightly above) intermediate member 355.

Housing 370 may include a lip 372 that may be a top curled portion of housing 370. Lip 372 may be disposed between (e.g., sandwiched between) lip member 330 and washer member 340 (e.g., with an adhesive such as an FDA-approved adhesive). Sleeve member 350 may be attached to washer member 340 and lip 372 (e.g., and sleeve member 350 may not be attached to other portions of housing 370, thereby forming gap 352). Gap 352 may be thereby formed between structural assembly 306 that may form an outer housing and housing 370 that may form an inner housing.

One or more thermal devices 375 may be disposed on and/or attached to housing 370. Thermal device 375 may be disposed on or at exterior surface 370a of housing 370 and/or disposed on or at interior surface 335a of housing 370. In at least some exemplary embodiments, thermal device 375 may be attached to housing 370 by any suitable technique such as, for example, adhesives, mechanical fasteners, welding, and/or any other suitable attachment technique. Thermal device 375 may be any suitable device for heating and/or cooling material disposed in cavity 385. For example, thermal device 375 may heat or cool the thermally conductive material of housing 370 and/or be disposed in cavity 385 to directly heat or cool material disposed in cavity 385. One thermal device 375 or a plurality of thermal devices 375 may be thermally connected (e.g., be in thermal contact) or coupled to housing 370 to provide heating or cooling to the material (e.g., food and/or beverage) disposed in cavity 385, via the thermally conductive material of housing 370.

In at least some exemplary embodiments, thermal device 375 may be formed from a flexible material so that thermal device 375 may conform to a shape of housing 370 (e.g., an annular, prismatic, cylindrical, or any other desired shape of housing 370). A single thermal device 375 or a plurality of thermal devices 375 may partially or substantially encircle an exterior surface of housing 370. Thermal device 375 may include any suitable flexible heating and/or cooling devices. Thermal device 375 may be a flexible heating and/or cooling device. Thermal device 375 may be attached to (e.g., adhered to or attached using any other suitable technique such as fasteners) an exterior surface of housing 370. In at least some exemplary embodiments, thermal device 375 may include a Polyimide heater, a silicone rubber heater, and/or a resistive wire heater (e.g., a nichrome wire heater). Thermal device 375 may include 22-gauge Nichrome wire (e.g., a wire 376). In at least some exemplary embodiments, one or more thermal devices 375 may include any suitable length of Nichrome wire (e.g., about 16 feet of resistive Nichrome wire disposed in a polyimide tape for example to provide substantially distributed heating without significant hot spots). Thermal device 375 may include polyimide tape that may be attached to an exterior surface of housing 370. U.S. Provisional Patent Application No. 63/180,511 filed Apr. 27, 2021, which is incorporated by reference in its entirety as set forth above, provides additional exemplary embodiments of Nichrome wire arrangements and other configurations that may be utilized in thermal device 375. In at least some exemplary embodiments, thermal device 375 may include a heat sink (e.g., a relatively thin polymer film), a thermoelectric cooling or heating flexible plate (e.g., or plate configured to conform to a shape of housing 370), and/or any other suitable heating and/or cooling device that may heat and/or cool material disposed in cavity 385 via thermal contact with housing 370.

In at least some exemplary embodiments, apparatus 305 may include four thermal devices 375, with two sets of the four thermal devices 375 paired together in parallel (e.g., to each provide a heating circuit of 20 V and 2.5 A). The plurality of thermal devices 375 may together behave as one full 100 W 20 V heating element. Thermal device 375 may be suitable for (e.g., rated for) between about 110° C. and about 150° C.

Thermal device 375 may be partially or substantially entirely covered with any suitable material that may be thermally conductive and electrically non-conductive material (e.g., boron nitride and/or silicon carbide or any other suitable material) to substantially prevent electrical current being provided to housing 370 based on an operation of control assembly 365 and/or thermal assembly 335. One or more thermal devices 375 may be placed around side portions and/or a bottom portion of housing 370. One or more thermal devices 375 may be placed at portions of housing 370 that may be configured to receive material to efficiently transfer heat or cooling to a surface area of housing 370 corresponding to the portion of cavity 385 holding material to be heated or cooled. For example, one or more thermal devices 375 may be disposed at and/or up to a “fill line” or other suitable boundaries marking where material to be heated or cooled may be disposed (e.g., a “fill line” visible to a user so that heating or cooling is efficiently utilized and not wasted by heating or cooling portions of housing 370 not in direct contact with material to be cooked, cooled, or heated).

In at least some exemplary embodiments, a plurality of thermal devices 375 may be disposed or stacked vertically (e.g., disposed progressively up an exterior sidewall of housing 370 to optimize for different levels of material held in cavity 385). For example, a lower portion of housing 370 may include additional or greater coverage by thermal devices 375 relative to upper portions of housing 370. If a plurality of thermal devices 375 are utilized, thermal devices 375 may be toggled on or off utilizing the exemplary disclosed sensors and software modules to turn on thermal devices 375 suitable for optimizing efficiency of heating or cooling transfer from thermal devices 375 to the material disposed in cavity 385 (e.g., based on an operation of control assembly 365). For example, when cavity 385 is about half-full, any thermal devices above the midpoint of cavity 385 (corresponding to the midpoint on housing 370) may be turned off (e.g., to reduce energy waste) based on an operation of control assembly 365. Insulation 345 may cover some or substantially all thermal devices 375.

One or more sensors 380 may be attached to housing 370 (e.g., and/or portions of thermal devices 375). One or more sensors 380 may be placed on housing 370 (e.g., at multiple locations) to determine (e.g., indirectly determine) properties of the exemplary disclosed material housed in housing 370. One or more sensors 380 may be placed in direct contact with thermal devices 375 for example to act as a failsafe to turn off one or more thermal devices 375 if thermal devices 375 operate unsuitably or malfunction (e.g., if there is a thermal runaway).

Sensor 380 may be coupled to housing 370 and may be configured to capture data associated with material disposed in cavity 385 of housing 370. One or more sensors 380 may be configured to determine a material temperature of material disposed in cavity 385 of housing 370, a fill level of material disposed in cavity 385 of housing 370 (e.g., a height to which material is disposed in cavity 385), and/or a change of phase of material disposed in cavity 385 of housing 370 (e.g. liquid to vapor, e.g., boiling; vapor to liquid, e.g., condensation; liquid to solid, e.g., freezing). Sensor 380 may be configured to determine when a set parameter is reached (e.g., a threshold or predetermined temperature, the fill line being reached and/or an amount of material disposed in housing 370 dropping below or exceeding a threshold level, and/or a change in phase) and communicate data of the parameter to control assembly 365 for example as described herein. Control assembly 365 may operate based on data received from one or more sensors 380. For example, control assembly 365 may control each of one or more thermal devices 375 to turn on or off (e.g., when sensor 380 transfers data of material such as water held in cavity 385 reaching boiling and/or a predetermined temperature). For example, when sensor 380 determines that a material such as a beverage is changing phase from liquid to gas (e.g. boiling), sensor information may be transferred to and processed by the exemplary disclosed software modules of a controller of control assembly 365. For example, control assembly 365 may determine that a temperature is no longer rising at a threshold rate and is therefore experiencing a phase transition.

Sensor 380 may be any suitable device for sensing a parameter associated with a temperature of material disposed in cavity 385 of housing 370 (e.g., via a sensed temperature of housing 370), sensing a parameter for determining a fill level of material disposed in cavity 385 of housing 370, and/or sensing a parameter for determining a change of phase of material disposed in cavity 385 of housing 370. For example, sensor 380 may determine a temperature of material of housing 370, which may be transferred to and utilized by control assembly 365 in determining a temperature of material disposed in cavity 385 of housing 370, determining a fill level of material disposed in cavity 385 of housing 370, and/or determining a change of phase of material disposed in cavity 385 of housing 370. Sensor 380 may include any suitable temperature sensor. Sensor 380 may include a thermally sensitive resistor such as for example a thermistor. Sensor 380 may determine a temperature based on heat conductivity determination. For example, properties of material of housing 370 may be known or determined (e.g., sectional thickness, amount by which a member may be heated, and/or any other suitable properties), and these properties may be used by control assembly 365 in addition to temperature data sensed by sensor 380 to determine a temperature of material disposed in cavity 385 of housing 370. In at least some exemplary embodiments, sensor 380 may be a thermal-pulse-emitting sensor, a resistance temperature detector sensor, or a thermal-ribbon sensor. In at least some exemplary embodiments, sensor 380 may include a strain gauge that measures a strain of housing 370 due to temperature change that may be used by control assembly 365 to determine a temperature of material disposed in cavity 385 of housing 370.

For example as illustrated in FIGS. 2 and 5-8, control assembly 365 may include a controller 390, a power component 395, a face member 400, and a display assembly 405. Face member 400 may help support power component 395. Power component 395 may transfer power to controller 390 and other electrical components of apparatus 305. Controller 390 may control display assembly 405 and other electrical components of apparatus 305.

For example as illustrated in FIGS. 2 and 8, face member 400 may be disposed in cavity 362 and may be supported between and/or attached to base member 360 and/or intermediate member 355 via any suitable technique (e.g., via mechanical fasteners such as snap joints, screws, adhesive, and/or any other suitable technique). Face member 400 may be formed from material similar to intermediate member 355, sleeve member 350, and/or lip member 330. Face member 400 may include an aperture 410 that may be configured to receive a portion of an external power source such as, for example, connector 320 of power source 310. Face member 400 may provide a protective cover for power component 395. In at least some exemplary embodiments, base member 360 may include a door that may fit into aperture 410. Face member 400 (e.g., or base member 360) may also include a movable member 402 (e.g., a door) that may be selectively received in aperture 410 (e.g., or an aperture of base member 360) to improve a water resistivity of a port (e.g., a USB port such as a USB-C port) of control assembly 365 and/or to provide suitable weatherability of the port by keeping dirt, debris, and other elements out of the port.

Power component 395 may be disposed in cavity 362 and may be supported by and/or attached to base member 360, intermediate member 355, and/or face member 400 via any suitable technique (e.g., via mechanical fasteners such as snap joints, screws, adhesive, and/or any other suitable technique). For example as illustrated in FIG. 8, power component 395 may include a port member 415 for connecting to a portion of an external power source that may be inserted through aperture 410 of face member 400 such as, for example, connector 320 of power source 310. Port member 415 may be any suitable electrical port such as a USB port or any other suitable electrical power port or port used for monitoring components of control assembly 365 and/or thermal assembly 335. Port member 415 may be a USB-C port that may be rated to 60 W or more. Port member 415 may be rated as a water-resistant port (e.g., may be a water-resistant port). Power component 395 may also receive power wirelessly from a wireless power system.

Controller 390 may be electrically connected to power component 395 and may be powered via a power source such as external power source 310 via power component 395. Controller 390 may be disposed in any suitable portion of apparatus 305 such as, for example, in cavity 362 and may be supported by and/or attached to base member 360, intermediate member 355, face member 400, and/or power component 395 via any suitable technique (e.g., via mechanical fasteners such as snap joints, screws, adhesive, and/or any other suitable technique).

Controller 390 may control an operation of apparatus 305. The controller may include for example a processor (e.g., micro-processing logic control device) or board components. Also for example, controller 390 may include input/output arrangements that allow it to be connected (e.g., via wireless, Wi-Fi, Bluetooth, or any other suitable communication technique) to other components of system 300. For example, controller 390 may control an operation of apparatus 305 based on input received from an exemplary disclosed module of system 300 (e.g., as described below), user device 315, and/or input provided directly to monitoring device 305 by a user (e.g., via any suitable user interface such as, for example, a user interface 420) provided on apparatus 305 such as a keypad, button, and/or a touchscreen. Controller 390 may communicate with components of system 300 via wireless communication, Wi-Fi, Bluetooth, network communication, internet, and/or any other suitable technique (e.g., as disclosed herein).

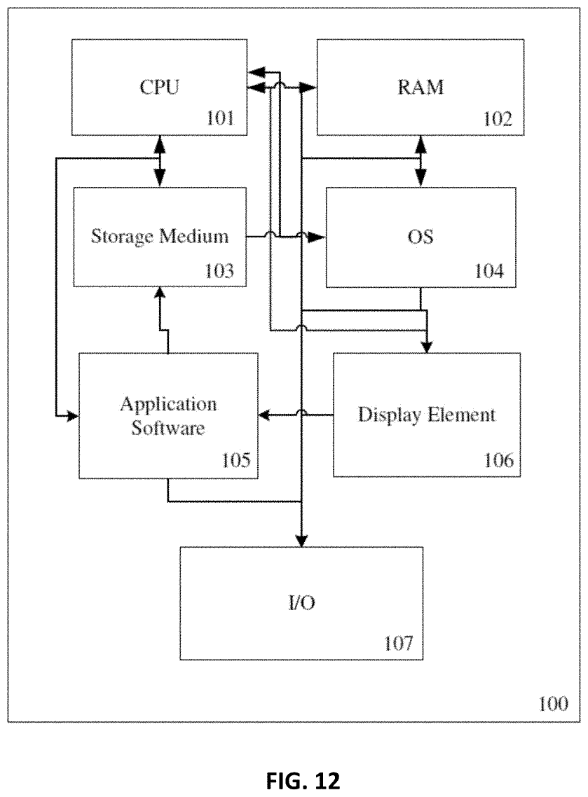

System 300 may include one or more modules that may be partially or substantially entirely integrated with one or more components of system 300 such as, for example, controller 390, user device 315 and/or any of the exemplary disclosed networks (e.g., cloud-based) described herein. The one or more modules may be software modules as described for example below regarding FIG. 12. For example, the one or more modules may include computer-executable code stored in non-volatile memory. The one or more modules (e.g., a module for Bluetooth communication, a module for Wi-Fi communication, a module for executing the exemplary disclosed algorithms, and/or any other suitable module) may store data and/or be used to control some or all of the exemplary disclosed processes described herein.

Controller 390 may communicate with user device 315 and/or user interface 420, which may include buttons (e.g., physical or capacitive touch), wherein a user may toggle a set temperature (e.g., such as to a predetermined temperature such as 60° C., wherein the apparatus may stop heating when one or more sensors sense data indicative of material disposed in cavity 385 being at a predetermined temperature based on processing by controller 390 or user input). User device 315 and/or user interface 420 may be used to toggle thermal devices 375 on or off, and/or may be used to toggle which sensor 380 should have information displayed via display assembly 405 and/or user device 315. In at least some exemplary embodiments, controller 390 may automatically toggle between thermal devices 375 and between information of various sensors 380 to be displayed based on a power source (e.g., power source 310) being plugged in or unplugged from power component 395. Controller 390 may run software such as the exemplary disclosed module for managing and controlling one or more thermal devices 375, one or more sensors 380, display assembly 405, and/or user interface 420. Controller 390 may manage and control a power (e.g., current and voltage levels) of the exemplary disclosed electrical components (e.g., thermal devices 375, sensors 380, and/or other suitable components) of apparatus 305.

Display assembly 405 may be disposed at any suitable portion of apparatus 305. For example, display assembly 405 may be disposed in gap 352 between thermal assembly 335 and sleeve member 350. Display assembly 405 may also be disposed at an exterior surface of sleeve member 350 (e.g., and/or base member 360 and/or lip member 330). Display assembly 405 may include any suitable display element such as lighting elements 425 that may be visible to a user. For example, lighting elements 425 may include light-emitting diodes (LEDs), organic light-emitting diodes (OLED), electroluminescent lighting elements (ELs), and/or any other suitable lighting elements. Lighting elements 425 may emit light that may be visible to a user through one or more portions of sleeve member 350 that may be partially or substantially entirely transparent or translucent. For example when display assembly 405 is disposed in gap 352, light displayed by lighting elements 425 may be visible to a user through transparent or translucent portions of sleeve member 350. Display assembly 425 may display any desired output to a user. Display assembly 425 may display any suitable patterns, colors, text displays, symbols, and/or any other display of desired data output to a user regarding an operation of apparatus 305 (e.g., and/or emit an audio output). Display assembly 425 may also include one or more actuators 430. Actuator 430 may be a button or any other suitable actuator that may be used by a user to adjust settings and/or control apparatus 305. Actuator 430 may be a capacitive touch button that can be sensed through sleeve member 350 for example when display assembly 425 is disposed in gap 352. In at least some exemplary embodiments, lip member 330 and/or base member 360 may be transparent or translucent similar to sleeve member 350 (e.g., and may include a similar capacitive touch button).

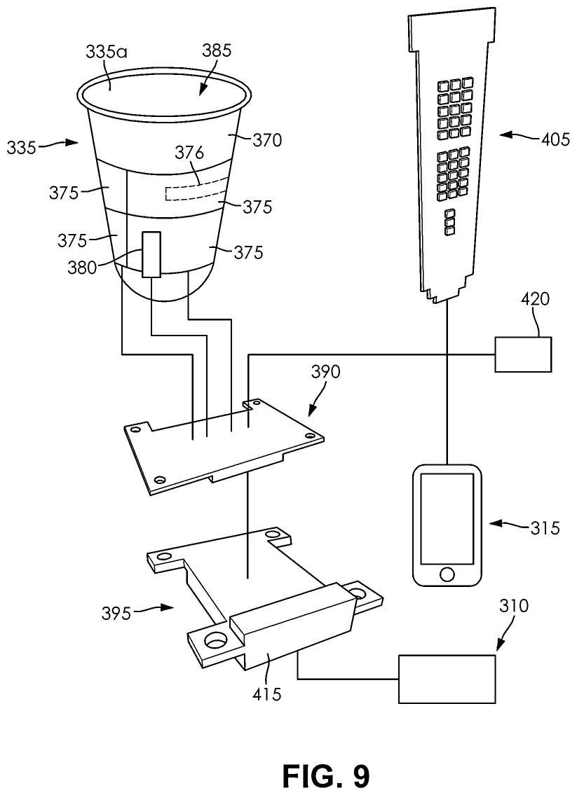

As illustrated in FIG. 9, controller 390 may be communicatively coupled with, exchange input and/or output with, and/or control any suitable component of apparatus 305. For example, controller 390 may be communicatively coupled with, exchange input and/or output with, and/or control one or more thermal devices 375, one or more sensors 380, display assembly 405, and/or user interface 420. Controller 390 may be communicatively coupled with thermal devices 375, one or more sensors 380, display assembly 405, and/or user interface 420 via electrical line or wire and/or via any other suitable exemplary disclosed technique such as wireless communication, Wi-Fi, Bluetooth, network communication, internet, and/or any other suitable technique (e.g., as disclosed herein). Controller 390 may also be similarly communicatively coupled with user device 315 and/or external components via power component 395.

In at least some exemplary embodiments, the exemplary disclosed apparatus may be a flameless cooking system for backcountry use for heating material such as food and beverages (e.g., water). The exemplary disclosed apparatus may include a double-walled bottle (e.g., a double-walled water bottle) formed by sleeve member 350 and housing 370.

In at least some exemplary embodiments, some or substantially all materials utilized for lid member 325, lip member 330, and washer member 340 may be FDA-approved and may be suitable for (e.g., tolerant of) temperatures of at least 100° C. (e.g., at least a temperature for boiling water). Lid member 325 may be constructed from multiple components that may be adhered together using an FDA-approved adhesive. The exemplary disclosed adhesive may be suitable for (e.g., tolerant of) temperatures of at least 100° C. (e.g., at least a temperature for boiling water). The exemplary disclosed adhesive may be water-resistant (e.g., water-insoluble). As an alternative (e.g., or in addition to) using adhesives, the exemplary disclosed components of apparatus 305 may be over-molded together for example based on using an injection molding process (e.g., in which case materials of the exemplary disclosed components of apparatus 305 may be chemically bonded to each other as they are formed). In at least some exemplary embodiments, ultrasonic welding may be used to join exemplary disclosed components that may be polycarbonate parts to each other.

In at least some exemplary embodiments, some or substantially all of the exemplary disclosed electrical components may be suitable for (e.g., rated for) temperatures of at least 85° C. Some of the exemplary disclosed electrical components may be disposed (e.g., spread across) one or more circuit boards of controller 390 (e.g., one or more circuit boards of controller 390 may be disposed below intermediate member 355 and one or more circuit boards of controller 390 may be disposed in gap 352 along sleeve member 350 for controlling display assembly 405).

In at least some exemplary embodiments, power transferred from power source 310 to apparatus 305 via power component 395 may be transferred directly to thermal devices 375 and/or other exemplary disclosed components of apparatus 305 without conversion (e.g., without a power converter). For example, power rated at 100 W, 95 W, or any other suitable power level may be transferred directly to thermal devices 375 and/or other exemplary disclosed components of apparatus 305 without conversion.

The exemplary disclosed system, apparatus, and method may be used in any suitable application for electrical cooking, electrical heating, electrical cooling, and/or any other suitable application utilizing electricity. For example, the exemplary disclosed system, apparatus, and method may be used in any suitable application for remote cooking, heating, and/or cooling such as camping, hiking and backpacking, boating, military and law enforcement activities (e.g., field operations), travel (e.g., commuting, road trips, or air or train travel), remote construction work, and/or any other suitable activity occurring in a remote or backcountry location. The exemplary disclosed system, apparatus, and method may be used in any suitable remotely-located application such as activities occurring away from infrastructure such as electrical utilities and infrastructure. For example, the exemplary disclosed system, apparatus, and method may be used in remote forest, desert, and/or any other location located away from amenities such as kitchens and power sources (e.g., wall outlets).

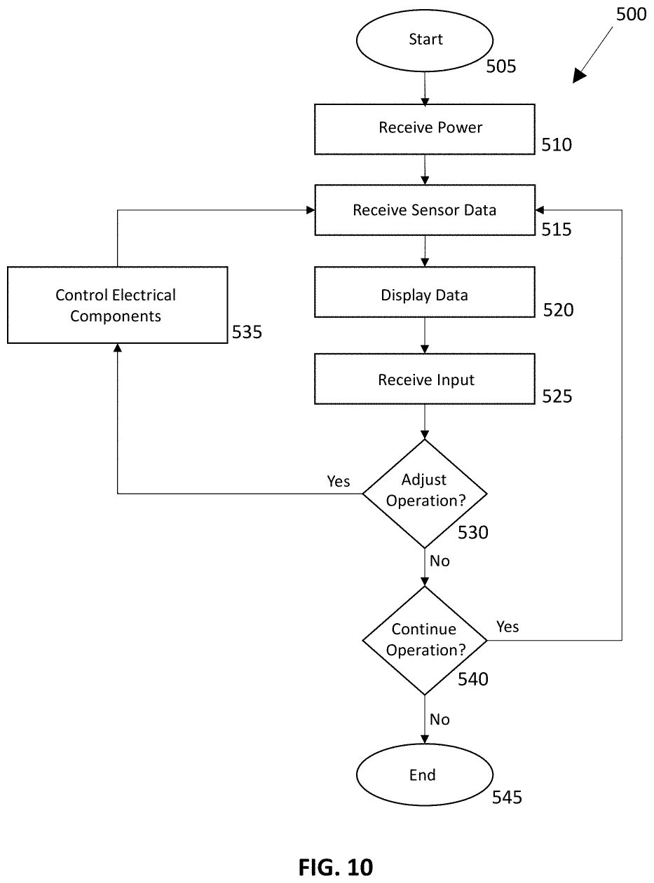

FIG. 10 illustrates an exemplary operation or algorithm of the exemplary disclosed system 300. Process 500 begins at step 505. At step 510, system 300 may receive power via any suitable technique such as, for example, the exemplary disclosed techniques described herein. For example, apparatus 305 may be powered by a power source such as external power source 310 via power component 395, based on power component 395 receiving power wirelessly from a wireless power system, and/or any other suitable technique. For example, apparatus 305 may be powered based on connector 320 (e.g., a USB port such as a USB-C port) being electrically connected to port member 415 that may be a USB-C port. One or more thermal devices 375 may begin operation at step 510 or may begin operation based on input being received and/or a predetermined operation based on an operation of controller 390 for example as described below.

At step 515, sensor data may be received by system 300. Sensor 380 may sense properties of material disposed in cavity 385 of housing 370 for example as described herein. Sensor 380 may sense and provide data to controller 390 that may be used by controller 390 to determine a temperature of material disposed in housing 370, whether material is disposed in housing 370 so as to be substantially equal to or greater than a fill line (e.g., a predetermined level) of housing 370, a change in phase of material disposed in housing 370, and/or any other suitable data for example as described herein. Data may be transferred from sensor 380 to controller 390 by any suitable technique for example as described herein. Controller 390 may process the data using any suitable components or processes for example as described herein.

At step 520, controller 390 may control display assembly 405 to display any desired output. For example, light displayed by lighting elements 425 may be visible to a user through transparent or translucent portions of sleeve member 350 for example as described herein. Display assembly 405 may display any suitable patterns, colors, text displays, symbols, and/or any other display of desired data output to a user regarding an operation of apparatus 305.

At step 525, system 300 may receive input from a user via user device 315, via user interface 420, and/or via display assembly 405. For example, user device 315 may transfer input data to controller 390 using any suitable technique such as described herein (e.g., wirelessly transfer data). Also for example, a user may enter input via buttons and/or any other suitable technique such as the exemplary disclosed buttons (e.g., capacitive touch buttons) of user interface 420 and/or display assembly 405 so that input data may be transferred to controller 390.

At step 530, system 300 may determine whether an operation of apparatus 305 should be changed based on data sensed at step 515 and/or input received at step 525. If an operation of apparatus 305 is to be adjusted, process 500 proceeds to step 535.

At step 535, controller 390 may control and/or adjust an operation of the exemplary disclosed components of apparatus 305. For example, controller 390 may control one or more thermal devices 375 to provide additional heat and/or cooling to material disposed in housing 370, turn on or off one or more thermal devices 375, change a display pattern of display assembly 405, transfer output to user device 315, adjust an operation of port member 415, adjust an operation of one or more sensors 380, and/or adjust any other operation of apparatus 305. Controller 390 may adjust an operation of apparatus 305 based on data sensed at step 515 and/or input received at step 525. Controller 390 may also adjust an operation of apparatus 305 based on predetermined criteria and/or one or more algorithms based on an operation of the exemplary disclosed module. For example, controller 390 may stop an operation of one or more thermal devices 375 based on a temperature sensed by one or more sensors 380 being greater (e.g., or less than) a predetermined (e.g., threshold) temperature and/or a change of phase of material disposed in cavity 385 of housing 370 being determined by controller 390 based on data sensed by sensors 380. Also for example, controller 390 may control thermal devices 375 to heat or cool material disposed in housing 370 to a predetermined temperature (e.g., and/or to a desired phase state) and then turn off one or more thermal devices 375 (e.g., based on data sensed and transferred by one or more sensors 380).

Controller 390 may separately control each of a plurality of thermal devices 375 to toggle on or off (e.g., and/or increase or decrease a heating or cooling level of material disposed in housing 370) based on data sensed at step 515 and/or input received at step 525 for example as described herein. For example, controller 390 may separately control each of a plurality of thermal devices 375 based on any suitable sensed data for example as described herein (e.g., based on a determined fill level, temperature, and/or phase state of material disposed in housing 370). Controller 390 may thereby control each of a plurality of thermal devices 375 for example as illustrated in FIG. 9 to operate independently of each other based on controller 390 processing sensed data received at step 515 (e.g., and/or input received at step 525) to determine properties of material disposed in housing 370.

Process 500 may then return to step 515 to receive updated sensor data sensed by sensors 380 following adjustments made by controller 390 to the exemplary disclosed electrical components at step 535. The exemplary disclosed steps may be interatively repeated as desired. If an operation is not to be adjusted, process 500 may proceed from step 530 to step 540.

At step 540, system 300 may determine whether or not to continue operation based on input received at step 525, data sensed at step 515, and/or based on a predetermined algorithm or automatic operation by controller 390 for example as described at step 535. Also for example, step 540 may occur between step 530 and step 535. If operation is to be continued, process 500 returns to step 515. If operation is to stop, process 500 may end at step 545.

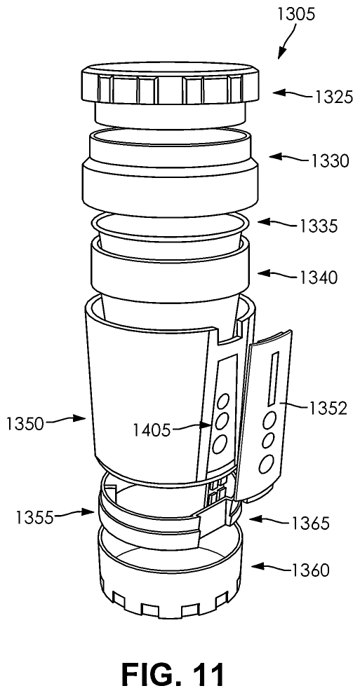

FIG. 11 illustrates an alternative exemplary embodiment of the exemplary disclosed system, apparatus, and method. Apparatus 1305 may be similar to apparatus 305 and may include a lid member 1325 that may be similar to lid member 325, a lip member 1330 that may be similar to lip member 330, a thermal assembly 1335 that may be similar to thermal assembly 335, a washer member 1340 that may be similar to washer member 340, a sleeve member 1350 that may be similar to sleeve member 350, an intermediate member 1355 that may be similar to intermediate member 355, a base member 1360 that may be similar to base member 360, and a control assembly 1365 that may be similar to control assembly 365. A removable member 1352 may be removably attached to sleeve member 1350 via any suitable technique such as, for example, mechanical fasteners, press-fit or snap-fit attachment, or any other suitable technique. A display assembly 1405 that may be similar to display assembly 405 may be selectively covered and accessed by a user via selectively removing and attaching removable member 1352.

In at least some exemplary embodiments, the exemplary disclosed apparatus may include an outer housing (e.g., including sleeve member 350), an inner housing (e.g., housing 370) disposed in the outer housing and forming a gap between an exterior surface of the inner housing and an interior surface of the outer housing, one or more thermal devices (e.g., thermal device 375) disposed in the gap, and an electrical port disposed in or on the outer housing and electrically connected to the one or more thermal devices. The exemplary disclosed apparatus may also include a display assembly that may be disposed in the gap adjacent to a portion of the outer housing that is transparent or translucent. The display assembly may be electrically connected to the electrical port and may include a capacitive touch button. The exemplary disclosed apparatus may further include a thermal sensor disposed in the gap and electrically connected to the electrical port. The one or more thermal devices may be disposed in or on a polyimide tape. The one or more thermal devices disposed in or on the polyimide tape may include resistive Nichrome wire. The polyimide tape may be attached to the exterior surface of the inner housing. The electrical port may be a USB-C port. The exemplary disclosed apparatus may also include an intermediate member that may be disposed in the outer housing and that may form a compartment between the intermediate member and the interior surface of the outer housing, the intermediate member separating the inner housing from the compartment. The exemplary disclosed apparatus may further include a controller disposed in the compartment that may be a watertight compartment, the controller electrically connected to the electrical port and to the one or more thermal devices.

In at least some exemplary embodiments, the exemplary disclosed method may include providing an outer housing (e.g., including sleeve member 350), disposing an inner housing (e.g., housing 370) in the outer housing and forming a gap between an exterior surface of the inner housing and an interior surface of the outer housing, disposing a plurality of thermal devices (e.g., thermal device 375) in the gap, disposing an electrical port in or on the outer housing, powering the plurality of thermal devices via the electrical port, and sensing a temperature at the exterior surface of the inner housing. The exemplary disclosed method may also include determining a material temperature of material disposed in the inner housing based on the sensed temperature. The exemplary disclosed method may further include determining an amount of material disposed in the inner housing based on the sensed temperature. The exemplary disclosed method may additionally include determining whether the material disposed in the inner housing is in a solid state, a liquid state, or a gaseous state based on the sensed temperature. The exemplary disclosed method may also include controlling an operation of each of the plurality of thermal devices independently of each other based on the sensed temperature. The plurality of thermal devices may be flexible heaters attached to the exterior surface of the inner housing. The exemplary disclosed method may further include emitting light from a display assembly disposed in the gap through a portion of the outer housing that is transparent or translucent.

In at least some exemplary embodiments, the exemplary disclosed apparatus may include an outer housing (e.g., including sleeve member 350), an inner housing (e.g., housing 370) disposed in the outer housing and forming a gap between an exterior surface of the inner housing and an interior surface of the outer housing, one or more thermal devices (e.g., thermal device 375) disposed in the gap, one or more sensors disposed in the gap, a display assembly disposed in the gap, a controller disposed in the outer housing, and an electrical port disposed in or on the outer housing and electrically connected to the one or more thermal devices, the one or more sensors, the display assembly, and the controller. The one or more thermal devices may be one or more nichrome wire heaters disposed in or on a flexible polyimide tape that may be attached to the exterior surface of the inner housing. The display assembly may include a plurality of lights and may be disposed in the gap adjacent to a portion of the outer housing that may be transparent or translucent.

The exemplary disclosed system, apparatus, and method may provide an efficient and effective technique for powering an thermal device (e.g., for electrical cooking, heating, and/or cooling). For example, the exemplary disclosed system, apparatus, and method may provide an electrical cooking solution that may be portable, lightweight, compact (e.g., not bulky), and/or easy to use. The exemplary disclosed system, apparatus, and method may be easily powered by readily available power sources such as commercially available batteries (e.g., plane-approved batteries).

An illustrative representation of a computing device appropriate for use with embodiments of the system of the present disclosure is shown in FIG. 12. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 13, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 13, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 13, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system may for example utilize collected data to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary disclosed system may utilize neural network-based artificial intelligence to predictively assess risk. For example, the exemplary neural network may include a plurality of input nodes that may be interconnected and/or networked with a plurality of additional and/or other processing nodes to determine a predicted result (e.g., a location as described for example herein).

For example, exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to make predictions based on data collected by the exemplary disclosed sensors.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation Kotlin, Swift, C#, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. An apparatus, comprising:
an outer housing;
an inner housing disposed in the outer housing and forming a gap between an exterior surface of the inner housing and an interior surface of the outer housing;
one or more thermal devices disposed in the gap; and
an electrical port disposed in or on the outer housing and electrically connected to the one or more thermal devices.

2. The apparatus of claim 1, further comprising a display assembly that is disposed in the gap adjacent to a portion of the outer housing that is transparent or translucent.

3. The apparatus of claim 2, wherein the display assembly is electrically connected to the electrical port and includes a capacitive touch button.

4. The apparatus of claim 1, further comprising a thermal sensor disposed in the gap and electrically connected to the electrical port.

5. The apparatus of claim 1, wherein the one or more thermal devices include resistive Nichrome wire.

6. The apparatus of claim 5, wherein the one or more thermal devices are disposed in or on a polyimide film.

7. The apparatus of claim 5, wherein the one or more thermal devices are attached to the exterior surface of the inner housing.

8. The apparatus of claim 1, wherein the electrical port is a USB-C port.

9. The apparatus of claim 1, further comprising an intermediate member that is disposed in the outer housing and that forms a compartment between the intermediate member and the interior surface of the outer housing, the intermediate member separating the inner housing from the compartment.

10. The apparatus of claim 9, further comprising a controller electrically connected to the electrical port and to the one or more thermal devices.

11. A method, comprising:
providing an outer housing;
disposing an inner housing in the outer housing and forming a gap between an exterior surface of the inner housing and an interior surface of the outer housing;
disposing a plurality of thermal devices in the gap;
disposing an electrical port in or on the outer housing;
powering the plurality of thermal devices via the electrical port; and
sensing a temperature at the exterior surface of the inner housing.

12. The method of claim 11, further comprising determining a material temperature of material disposed in the inner housing based on the sensed temperature.

13. The method of claim 11, further comprising determining an amount of material disposed in the inner housing based on the sensed temperature.

14. The method of claim 11, further comprising determining whether the material disposed in the inner housing is in a solid state, a liquid state, or a gaseous state based on the sensed temperature.

15. The method of claim 11, further comprising controlling an operation of each of the plurality of thermal devices independently of each other based on the sensed temperature.

16. The method of claim 11, wherein the plurality of thermal devices are flexible heaters attached to the exterior surface of the inner housing.

17. The method of claim 11, further comprising emitting light from a display assembly disposed in the gap through a portion of the outer housing that is transparent or translucent.

18. An apparatus, comprising:
an outer housing;
an inner housing disposed in the outer housing and forming a gap between an exterior surface of the inner housing and an interior surface of the outer housing;
one or more thermal devices disposed in the gap;
one or more sensors disposed in the gap;
a display assembly disposed in the gap;
a controller disposed in the outer housing; and
an electrical port disposed in or on the outer housing and electrically connected to the one or more thermal devices, the one or more sensors, the display assembly, and the controller.

19. The apparatus of claim 18, wherein the one or more thermal devices are one or more nichrome wire heaters disposed in or on a flexible polyimide film that is attached to the exterior surface of the inner housing.

20. The apparatus of claim 18, wherein the display assembly includes a plurality of lights and is disposed in the gap adjacent to a portion of the outer housing that is transparent or translucent.
